(19) United States
(12) Patent Application Publication
(10) Pub. No.: US 2016/0089879 A1
(43) Pub. Date: Mar. 31, 2016

(54) LIQUID EJECTION HEAD DRIVING SYSTEM

(71) Applicant: FUJIFILM Corporation, Tokyo (JP)

(72) Inventor: Hisayuki TANAKA, Kanagawa (JP)

(73) Assignee: FUJIFILM Corporation, Tokyo (JP)

(21) Appl. No.: 14/873,017

(22) Filed: Oct. 1, 2015

Related U.S. Application Data
(63) Continuation of application No. PCT/JP2014/058442, filed on Mar. 26, 2014.

(30) Foreign Application Priority Data
Apr. 2, 2013 (JP) 2013-077084

(51) Int. Cl. B41J 2/045

(52) U.S. Cl. CPC B41J 2/04541; B41J 2/04586

(57) ABSTRACT

A liquid ejection head driving system includes an ink jet head, a driving circuit substrate provided with a driving circuit in which a driving signal is generated, a driving signal wiring that branches an output of the driving circuit into two or more systems, and a plurality of connectors that extract the driving signal wiring for each system, and a flexible flat substrate (FFC) in which a connector connected to a connector of the driving circuit substrate is installed, a driving signal pattern for transmitting the driving signal for each system is formed on a first layer, and a reference potential pattern is formed on a second layer. The driving circuit substrate is configured such that the same number of connectors as the number of wiring substrates are mounted at a position where a direction of insertion and extraction of the connector of the FFC is released.

### CROSS-REFERENCE TO RELATED APPLICATIONS

The present application is a Continuation of PCT International Application No. PCT/JP2014/058442 filed on Mar. 26, 2014 claiming priority under 35 U.S.C §119(a) to Japanese Patent Application No. 2013-077084 filed on Apr. 2, 2013. Each of the above applications is hereby expressly incorporated by reference, in their entirety, into the present application.

### BACKGROUND OF THE INVENTION

1. Field of the Invention

The present invention relates to a liquid ejection head driving system, and particularly relates to a driving circuit substrate that supplies a driving signal (drive voltage) to a liquid ejection head and a wiring substrate that connects the liquid ejection head and the driving circuit substrate.

2. Description of the Related Art

As one of image forming methods in an ink jet recording apparatus, a method is known of using a (full) line-type ink jet head having a structure in which a plurality of nozzles that eject droplets onto a recording medium are disposed at equal intervals over a length corresponding to the maximum recording width of the recording medium along the width direction of the recording medium perpendicular to the transport direction of the recording medium.

As a line-type ink jet head applied to this type, a structure is known in which a plurality of head modules are linked together along the width direction of the recording medium.

In the image forming method using a line-type ink jet head, scanning of the ink jet head (movement in the width direction of the recording medium) is not required, and an image can be formed by relatively moving the recording medium and the ink jet head along the transport direction of the recording medium with respect to each other.

In addition, in the image forming method using a line-type ink jet head, scanning of the ink jet head in a main scanning direction is not required, and thus an image can be stably formed at a designated position on the recording medium. In addition, as compared to a serial type in which an ink jet head is scanned in a main scanning direction, the length of a wiring substrate (flexible flat substrate) in which a power source, a data control signal, a power driving signal, and the like which are supplied to the ink jet head are transmitted can be made shorter, and a case does not occur in which the position of the wiring substrate changes flexibly.

Thus, the waveform quality of an electrical signal which is transmitted to the ink jet head is easily adjusted, and the wiring substrate serves as an antenna. Even when a problem occurs in which an electrical signal flowing through the wiring substrate radiates electromagnetic noise to the outside depending on a wiring length, it is possible to cope through a simple measure against noise in which a shield is used between the substrate and a housing.

As an example of a measure against electromagnetic noise radiated from a wiring substrate that electrically connects an ink jet head and a driving circuit substrate, a technique disclosed in JP1990-94139U (JP-H02-94139U) and JP1990-206579A (JP-H02-206579A) is known.

JP1990-94139U (JP-H02-94139U) discloses a measure against noise of a flexible cable for supplying a driving signal to an ink jet head (print head) which is transported in a reciprocating manner. This flexible cable is provided facing a signal pattern over the substantially entire surface of a shield electrode, and thus a reduction in the radiation of electromagnetic noise radiated from the flexible cable is achieved.

JP1990-206579A (JP-H02-206579A) discloses a measure against noise of an ink jet printer having a large number of nozzles. When a plurality of signal cables are used, the ink jet printer disclosed in the above document is provided with a shield plate which is signal-grounded between the signal cables. In addition, a method of preventing the coupling of noise when a plurality of cables are used superimposed on each other, such as providing each signal line with a signal-grounded ground line, is adopted.

### SUMMARY OF THE INVENTION

However, a line-type ink jet head is provided with an element, such as piezoelectric elements or heaters having a number corresponding to a large number of nozzles, which generates a pressure for pressurizing a liquid, and wirings having a number corresponding to the number of elements are required. Then, wirings having a number corresponding to the number of wirings to the element are also formed on a wiring substrate that electrically connects the ink jet head and a driving circuit substrate in which a drive voltage for bringing the element into operation is generated.

Generally, when the wiring substrate is disposed with the same width as that of the ink jet head, a space in which the wiring substrate is disposed is limited, and thus the addition of a shield wire (shield electrode) to the wiring substrate may not be able to implemented by restrictions on the space in which the wiring substrate is disposed.

In the measure against noise disclosed in JP1990-94139U (JP-H02-94139U), when the reference potential of a circuit on the ink jet head side and the reference potential of a circuit on the driving circuit substrate side are insulated from each other, and the reference potential is set to a driving waveform in the circuit on the ink jet head side, the shield wire is not able to be applied to the flexible cable that electrically connects the ink jet head and the driving circuit substrate.

In addition, the flexible cable becomes thicker by providing the shield wire, and the shield wire is not able to be provided by restrictions on the arrangement space of the flexible cable. Further, the flexible cable is provided with the shield wire, and thus the flexible cable increases in cost.

In the measure against noise disclosed in JP1990-206579A (JP-H02-206579A), when the reference potential of a circuit on the ink jet head side and the reference potential of a circuit on the driving circuit substrate side are insulated from each other, and the reference potential is set to a driving waveform in the circuit on the ink jet head side, a current corresponding to the driving waveform serving as a the reference potential flows through a line alternative to (signal line, power source line) a ground line, and thus it is difficult to obtain a noise suppression effect simply by overlapping a plurality of cables.

In addition, since it is necessary to additionally prepare the ground line, a cable size becomes larger, and costs also increase.

The present invention is contrived in view of such circumstances, an object thereof is to provide a liquid ejection head driving system that suppresses electromagnetic noise which is radiated from a wiring substrate, and is excellent in the maintenance of the wiring substrate or the like.

In order to achieve the above object, according to the present invention, there is provided a liquid ejection head driving system including: a liquid ejection head including a plurality of nozzles that eject a liquid and a plurality of pressurizing elements that pressurize the liquid ejected from the nozzles; a driving circuit substrate including a driving signal generation unit in which a driving signal supplied to the plurality of pressurizing elements is generated, a driving signal wiring that branches an output of the driving signal generation unit into two or more systems, and a plurality of circuit-side connectors that extract the driving signal wiring for each of the systems; a support member that supports the driving circuit substrate; and the same number of wiring substrates as that of the system in which a wiring-side connector connected to the circuit-side connector is installed, a driving signal pattern for transmitting the driving signal for each of the systems is formed on a first surface, and a reference potential pattern of the driving signal is formed on a second surface on an opposite side to the first surface, wherein the plurality of wiring substrates are disposed in parallel so as to be brought close to each other by causing the first surfaces to face each other, and the driving circuit substrate is configured such that the same number of circuit-side connectors as the number of wiring substrates are mounted at a position where a direction of insertion and extraction of the wiring-side connector of the wiring substrate is released.

According to the present invention, since a plurality of wiring substrates to which the driving signal branched into a plurality of systems is transmitted are disposed in parallel so s to be brought close to each other by causing the first surfaces to face each other, magnetic fields caused by currents of the driving signals generated in the respective wiring substrates cancel each other out, and the radiation of electromagnetic waves (electromagnetic noise) from the respective wiring substrates is suppressed.

In addition, since the driving circuit substrate has the circuit-side connector mounted at a position where the direction of insertion and extraction of the wiring-side connector provided in the wiring substrate is released, it is possible to easily perform the attachment and detachment of the wiring substrate to and from the driving circuit substrate during maintenance, without any interference when the wiring-side connector is inserted and extracted.

### BRIEF DESCRIPTION OF THE DRAWINGS

FIG. 1 is a configuration diagram illustrating a schematic configuration of an ink jet head driving system according to an embodiment of the present invention.

FIG. 2 is a side view illustrating a connection configuration between an ink jet head and a driving circuit substrate.

FIG. 3 is a plan view when the ink jet head is seen from a nozzle surface side.

FIG. 4 is a perspective view illustrating a structural example of a head module.

FIG. 5 is a diagram illustrating a nozzle array of the head module.

FIG. 6 is a cross-sectional view illustrating an internal structure of the head module.

FIG. 7 is an exploded perspective view illustrating a configuration example of a housing frame and a cover.

FIG. 8 is a block diagram illustrating an electrical configuration of the driving circuit substrate, a flexible flat substrate and the head module.

FIG. 9A is a diagram illustrating a problem of the present invention, and is a diagram illustrating a magnetic field distribution which is generated in the flexible flat substrate.

FIG. 9B is a diagram illustrating a problem of the present invention, and is a diagram illustrating a magnetic field distribution when the flexible flat substrates are caused to face each other and are disposed in parallel close to each other.

FIG. 10 is a diagram illustrating a dipole (T-type) antenna.

FIGS. 11A and 11B are perspective views illustrating an entire structure of the flexible flat substrate; FIG. 11A is a diagram when seen from the lateral side, and FIG. 11B is a diagram when seen from the upper side.

FIG. 12 is a side view schematically illustrating a connection configuration between the flexible flat substrate and the driving circuit substrate.

FIG. 13 is a side view schematically illustrating another connection configuration between the flexible flat substrate and the driving circuit substrate.

FIGS. 14A and 14B are diagrams schematically illustrating still another connection configuration between the flexible flat substrate and the driving circuit substrate; FIG. 14A is an entire side view, and FIG. 14B is a partial front view of the driving circuit substrate.

FIG. 15 is an entire configuration diagram of an ink jet recording apparatus to which the ink jet head driving system according to the embodiment of the present invention is applied.

### DESCRIPTION OF THE PREFERRED EMBODIMENTS

Hereinafter, a preferred embodiment of the present invention will be described with reference to the accompanying drawings.

[Entire Configuration of Ink Jet Head Driving System]

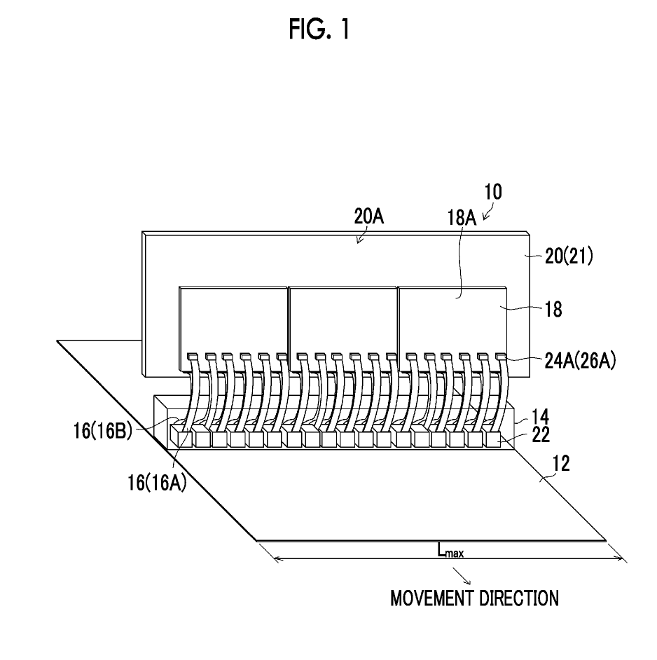

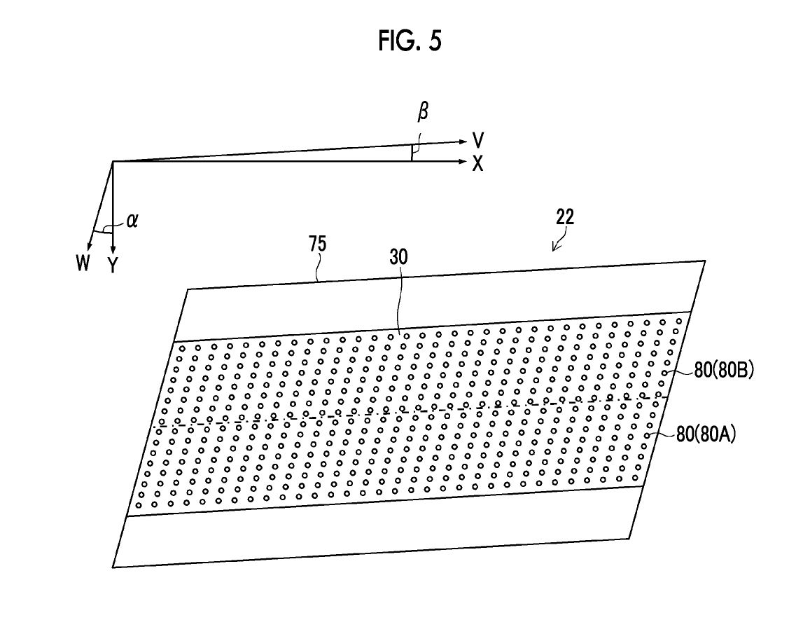

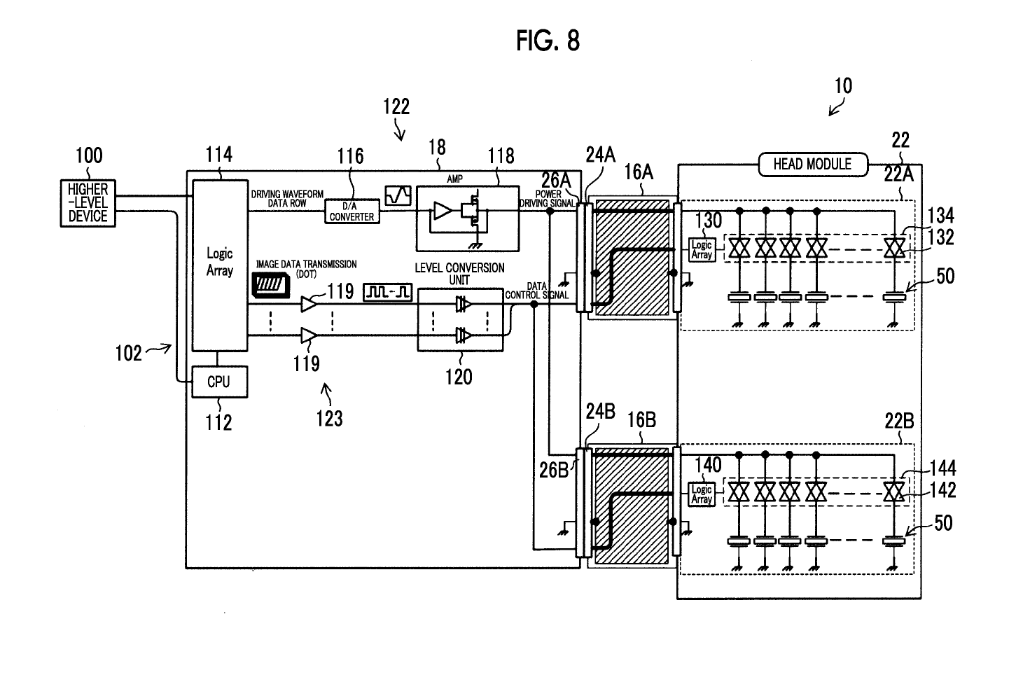

FIG. 1 is a configuration diagram illustrating a schematic configuration of an ink jet head driving system (liquid ejection head driving system) according to an embodiment of the present invention. An ink jet head driving system 10 shown in the drawing is configured to include a full line-type ink jet head 14 (liquid ejection head) in which nozzle openings (which are not shown in FIG. 1 and are shown by symbol 80 in FIG. 5) are disposed over a length corresponding to a maximum ejection width Lₘₐₓ of a recording medium 12 (medium), a flexible flat substrate 16 (16A, 16B, wiring substrate) to which a power driving signal (driving signal) and a data control signal (driving signal) which are supplied to the ink jet head 14 are transmitted, a driving circuit substrate 18 in which a driving circuit (shown by symbol 102 in FIG. 8) that supplies the power driving signal and the data control signal to the ink jet head 14 is mounted, and a housing frame 20 (and cover 21, support member) that supports the driving circuit substrate 18 from the back side.

The system includes a relative movement portion (a relative movement device which is not shown) that relatively moves the full line-type ink jet head 14 and the recording medium 12, shown in FIG. 1, with respect to each other, and is configured to relatively move the recording medium 12 and the ink jet head 14 with respect to each other only one time, thereby allowing liquid to be ejected throughout the entire ejection region (region onto which liquid is ejected) of the recording medium 12.

A direction shown by an arrow line in FIG. 1 indicates a relative transport direction of the recording medium 12 and the ink jet head 14. FIG. 1 shows a configuration in which the recording medium 12 is moved with respect to the fixed ink jet head 14, and a relative movement direction in this configuration is set to the movement direction (transport direction) of the recording medium 12.

The term “width of the recording medium 12” as used herein refers to the total length in a direction (width direction of the recording medium 12) perpendicular to the relative movement direction of the recording medium 12 and the ink jet head 14 in the recording medium 12. In addition, the “ejection width of the recording medium 12” refers to the total length in the width direction of the recording medium 12 of a region to which liquid of the recording medium 12 is attached.

The term “perpendicular” in the present specification not only includes the relation of intersection at 90°, but also the relation of intersection at angles other than 90° exhibiting the same operational effect as that of the relation of intersection at 90°.

Although described later in detail, the ink jet head 14 shown in FIG. 1 has a structure in which a plurality of head modules 22 are linked together in a row along the width direction of the recording medium 12, and is configured such that two flexible flat substrates 16A and 16B are connected to each of the head modules 22.

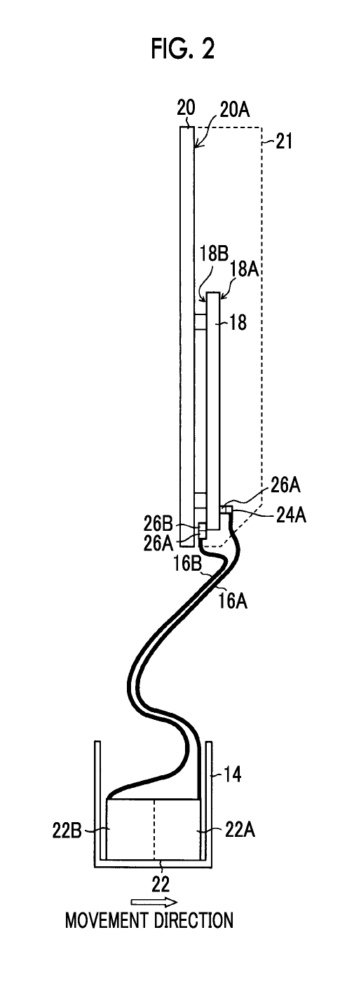

That is, the head module 22 has a structure in which the module is divided into two blocks (see FIG. 2), and is configured such that one flexible flat substrate 16A is connected to one block (shown by symbol 22A in FIG. 2) and the other flexible flat substrate 16B is connected to the other block (shown by symbol 22B in FIG. 2).

The head module 22 shown in the present example is configured such that two blocks 22A and 22B are disposed along the movement direction of the recording medium 12, one block 22A is disposed on the downstream side in the same direction, and that the other block 22B is disposed on the upstream side in the same direction.

A connector 24 (circuit-side connector) is installed on one end of the flexible flat substrate 16. This connector 24 is connected to a connector 26 (wiring-side connector) which is mounted on the driving circuit substrate 18. In addition, the other end of the flexible flat substrate 16 is bonded to an internal wiring or an extraction electrode (driving signal transmission wiring which is not shown) of the head module 22.

For example, an aspect is considered in which the connector 26 which is mounted on the driving circuit substrate 18 is used as a receptacle, and the connector 24 which is installed on the flexible flat substrate 16 is used as a plug.

The driving circuit substrate 18 has driving circuits (see FIG. 8) of a plurality of head modules 22 mounted therein. FIG. 1 shows an aspect in which three driving circuit substrates 18 are included, and six head modules' 22 worth of driving circuits are mounted in one driving circuit substrate 18.

In addition, FIG. 1 shows an aspect in which three driving circuit substrates 18 are lined up in a row along the width direction of the recording medium 12.

Meanwhile, the number of driving circuit substrates 18, the number of drive circuits mounted in one driving circuit substrate, and the number of head modules 22 are not limited to the shown example. For example, all the driving circuits of the ink jet head may be mounted in a state where the number of driving circuit substrates is set to one, and the number of driving circuit substrates may be set to two by dividing all the driving circuits of the ink jet head into two parts. Further, the number of driving circuit substrates may be set to four or more by dividing all the driving circuits of the ink jet head into four parts or more.

In the example shown in FIG. 1, six head modules' 22 worth of driving circuits are mounted in one driving circuit substrate 18, and the power driving signal and the data control signal are supplied from one driving circuit substrate 18 to six head modules 22.

Twelve flexible flat substrates 16 (six of each of the flexible flat substrates 16A and 16B) are connected to one driving circuit substrate 18, two flexible flat substrates forming a pair are connected to one head module 22, pairs of a plurality of flexible flat substrates 16A and 16B are arrayed in a row along the width direction of the recording medium 12, and two flexible flat substrates 16A and 16B forming a pair are disposed in parallel facing each other along the movement direction of the recording medium 12.

On the other hand, the flexible flat substrates 16A and 16B are configured such that the flexible flat substrates 16A and 16B are non-parallel to each other in the vicinity of the head module 22 and in the vicinity of connectors 24A and 24B, but the non-parallel portions have lengths (minimum lengths required for connection between the head module 22 and the driving circuit substrate 18) sufficiently shorter than those of parallel portions which are disposed in parallel facing each other.

The driving circuit substrate 18 is disposed above the ink jet head 14, and is disposed in a state where a component surface (component mounting surface, release surface) 18A having electronic parts or the like mounted thereon is vertically erected toward the movement direction of the recording medium 12.

The housing frame 20 supports the driving circuit substrate 18 from the solder surface (shown by symbol 18B in FIG. 2) side on the rear side of the component surface 18A. That is, the housing frame 20 is supported by a frame (not shown) in a state where a support surface 20A for supporting the driving circuit substrate 18 is erected vertically (in parallel to the driving circuit substrate 18) toward the movement direction of the recording medium 12.

Meanwhile, in the operating state of the ink jet head 14, the cover 21 (not shown in FIG. 1; see FIG. 2) is installed on the driving circuit substrate 18 side.

In the present example, an aspect is illustrated in which the driving circuit substrate 18 is supported in a state of being erected at right angles to the ink jet head 14, but the driving circuit substrate 18 may be erected obliquely with respect to the ink jet head 14.

Meanwhile, the driving circuit substrate 18 may be laid down at right angles to the ink jet head 14, but it is preferable that the upper side thereof is set to the component surface in consideration of the radiation of heat of components which are mounted on the driving circuit substrate 18.

FIG. 2 is a side view illustrating a connection configuration between the ink jet head 14 (head module 22) and the driving circuit substrate 18. An arrow line shown in the drawing indicates the movement direction of the recording medium 12.

As shown in FIG. 2, the driving circuit substrate 18 is configured such that a straight angle-type connector 26A is mounted on the lower end of the component surface 18A. In addition, a right angle-type connector 26B is mounted on the lower end of the solder surface 18B (support surface) serving as a rear surface of the component surface 18A.

Meanwhile, the “component surface” and the “solder surface” of the driving circuit substrate 18 are named for the sake of convenience. The component surface 18A is a surface on which electronic parts are generally mounted and a wiring pattern is formed, and the solder surface 18B is a surface on which a wiring pattern, an extraction electrode and the like are formed and soldering is performed. However, electronic parts can also be mounted on the solder surface.

The wiring pattern includes signal lines which are connected to each of a plurality of head modules and return lines (reference potential lines) of the signal lines. The signal lines and the return lines are respectively disposed in parallel to each other. Meanwhile, the reference potential line may have a line width larger than that of the signal line, and may be formed in a planar shape.

The connector 24A installed on one end of the flexible flat substrate 16A connected to the block 22A constituting the head module 22 is connected to the connector 26A mounted on the component surface 18A of the driving circuit substrate 18.

In addition, the connector 24B installed on one end of the flexible flat substrate 16B connected to the block 22B is connected to the connector 26B mounted on the solder surface 18B of the driving circuit substrate 18.

FIG. 2 illustrates an aspect in which one flexible flat substrate 16A and one flexible flat substrate 16B are used as a pair, but one flexible flat substrate 16A and two or more flexible flat substrates 16B may be used as a pair in a state where any of the flexible flat substrates 16A and 16B is divided into a plurality of parts.

[Description of Structure of Ink Jet Head]

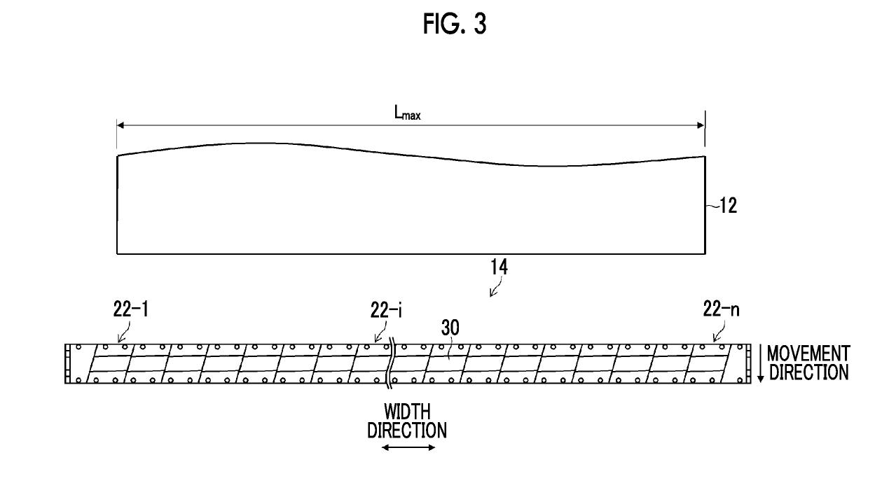

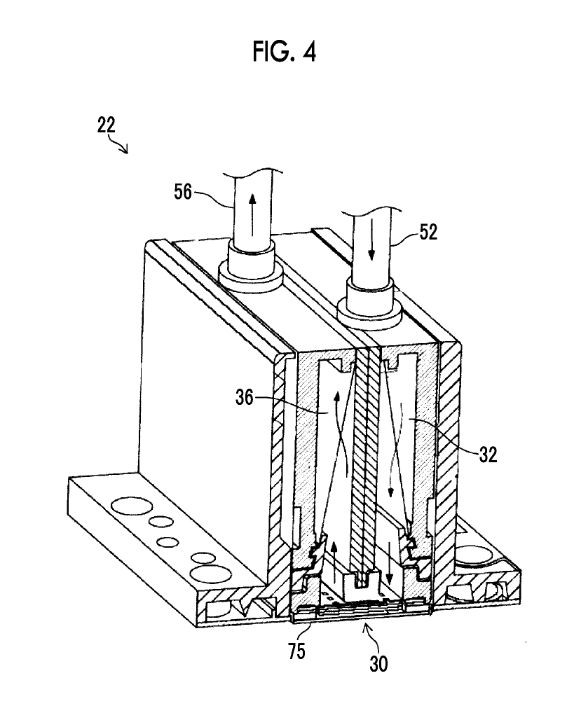

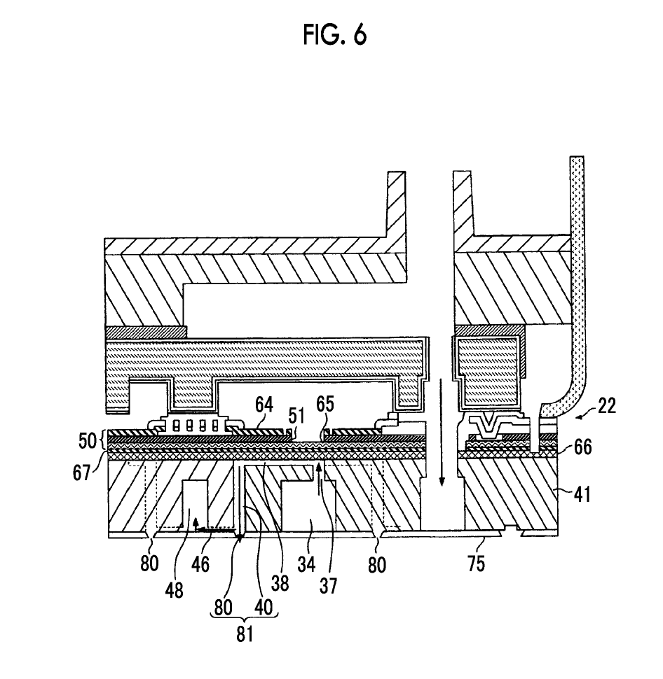

Next, the details of the ink jet head 14 (head module 22-i) will be described. FIG. 3 is a plan view (perspective plan view) when the ink jet head 14 is seen from the nozzle surface side. In addition, FIG. 4 is a perspective view illustrating a configuration example of the head module 22, FIG. 5 is a diagram illustrating a nozzle array of the head module 22, and FIG. 6 is a cross-sectional view illustrating an internal structure of the head module 22.

Although not shown in FIG. 3 for convenience for illustration, a plurality of nozzle openings (shown by symbol 80 in FIG. 5) for ejecting liquid are disposed on a nozzle surface 30. Meanwhile, a branch number given to the head module 22 of FIG. 3 indicates an i-th (i is an integer of 1 to n) head module.

As shown in FIG. 4, the head module 22 includes an ink supply unit constituted by an ink supply chamber 32, an ink circulation chamber 36 and the like on the opposite side (upper side in FIG. 4) to the nozzle surface 30 of a nozzle plate 75.

The ink supply chamber 32 is connected to an ink tank (not shown) through a supply pipe line 52, and the ink circulation chamber 36 is connected to a recovery tank (not shown) through a circulation pipe line 56.

The number of nozzles is omitted in FIG. 5, but a plurality of nozzle openings 80 are formed by a two-dimensional nozzle array on the nozzle surface 30 of the nozzle plate 75 of one head module 22.

That is, the head module 22 is formed in a planar shape of a parallelogram including an end surface of a long side along a V direction having an inclination of an angle β with respect to an X direction and an end surface of a short side along a W direction having an inclination of an angle α with respect to a Y direction, and is configured such that a plurality of nozzle openings 80 are disposed in a row direction along the V direction and in a column direction along the W direction.

The X direction of FIG. 5 corresponds to the width direction of the recording medium 12 of FIG. 1, and the Y direction of FIG. 5 corresponds to the movement direction of the recording medium 12 of FIG. 1.

A broken line shown in FIG. 5 is a virtual line indicating a boundary between a nozzle opening 80A of a nozzle portion (shown by symbol 81 in FIG. 6) belonging to the block 22A and a nozzle opening 80B of a nozzle portion belonging to the block 22B. In this manner, a plurality of nozzle openings 80 are divided into two blocks.

The ink jet head 14 (head module 22) shown in the present example is configured such that the numbers of nozzles and the nozzle arrangements of the respective blocks 22A and 22B are the same as each other. Meanwhile, the nozzle arrangements of the respective blocks 22A and 22B can also be symmetrical to each other with respect to a boundary line.

The arrangement of the nozzle openings 80 is not limited to an aspect shown in FIG. 5, and a plurality of nozzle openings 80 may be disposed in a row direction along the X direction, and along a column direction obliquely intersecting the X direction.

Symbol 34 of FIG. 6 is an ink supply channel, 38 is a pressure chamber (liquid chamber), 37 is an individual supply channel (supply diaphragm flow channel) that connects the pressure chamber 38 and the ink supply channel 34, 40 is a nozzle communication channel which is connected to the nozzle opening 80 from the pressure chamber 38, and 46 is a circulation individual flow channel that connects the nozzle communication channel 40 and a circulation common flow channel 48.

A vibration plate 66 is provided on a flow channel structure 41 constituting these flow channel portions (34, 37, 38, 40, 46, and 48). A piezoelectric element 50 constituted by a laminated structure of a lower electrode (common electrode) 65, a piezoelectric layer 51 and an upper electrode (individual electrode) 64 is arranged on the vibration plate 66 through an adhesive layer 67.

The upper electrode 64 serves as an individual electrode which is patterned corresponding to a shape of each pressure chamber 38, and is provided with the piezoelectric element 50 (pressurizing element) for each pressure chamber 38.

The ink supply channel 34 is connected to the ink supply chamber 32 described in FIG. 4, and ink is supplied from the ink supply channel through the supply diaphragm flow channel 37 to the pressure chamber 38. A power driving signal is applied to the upper electrode 64 of the piezoelectric element 50 provided in a corresponding pressure chamber 38 in accordance with an image signal of an image to be plotted, and thus the piezoelectric element 50 and the vibration plate 66 are deformed to thereby lead to a change in the volumetric capacity of the pressure chamber 38, and ink is ejected from the nozzle opening 80 through the nozzle communication channel 40 due to a pressure change associated therewith.

Driving of the piezoelectric element 50 corresponding to each nozzle opening 80 is controlled in accordance with dot arrangement data (data control signal) which is generated from ejection data, thereby allowing ink droplets to be ejected from the nozzle opening 80. While the recording medium 12 (see FIG. 1) is transported in the Y direction at a constant rate, an ink ejection timing from each nozzle opening 80 is controlled in accordance with the transport speed, thereby allowing a desired image to be recorded on a sheet.

Although not shown in the drawing, the pressure chamber 38 which is provided corresponding to each nozzle opening 80 is approximately square in planar shape, and is configured such that one of both corner portions on the diagonal line is provided with an outflow port to the nozzle opening 80, and that the other corner portion is provided with the individual supply channel 37.

Meanwhile, the shape of the pressure chamber is not limited to a square. The planar shape of the pressure chamber may be various forms such as a quadrangle (such as a rhombus or a rectangle), a pentagon, a hexagon, other polygons, a circle, and an ellipse.

Ink which is not used for ejection in ink of the nozzle portion 81 is recovered (circulated) to the circulation common flow channel 48 through the circulation individual flow channel 46.

The circulation common flow channel 48 is connected to the ink circulation chamber 36 described in FIG. 4, and an increase in the viscosity of ink of the nozzle portion 81 during non-ejection (non-driving) is prevented by ink being recovered to the circulation common flow channel 48 through the circulation individual flow channel 46 at all times.

[Description of Housing Frame and Cover]

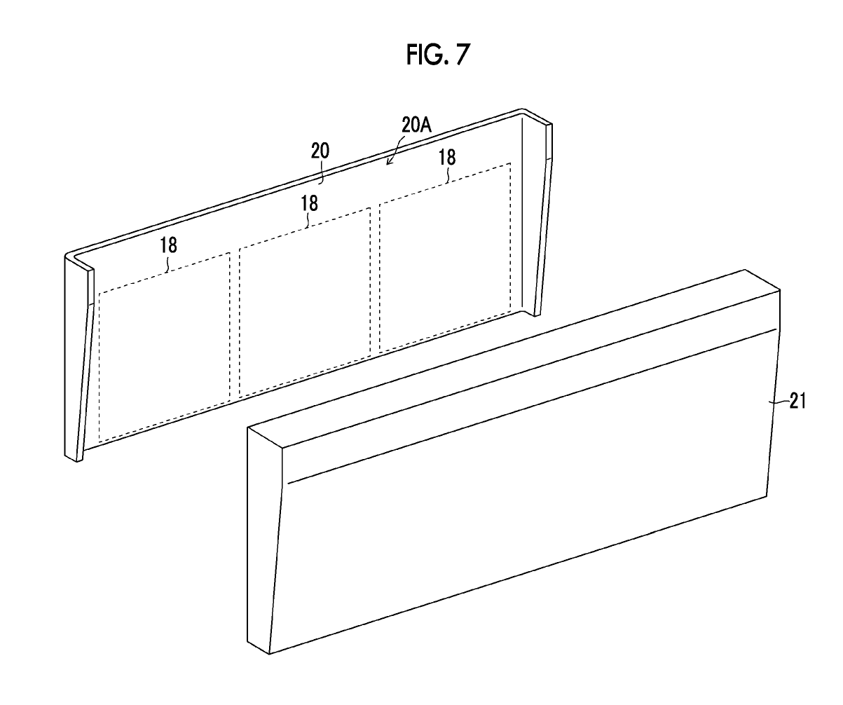

FIG. 7 is an exploded perspective view illustrating a configuration example of the housing frame 20 and the cover 21. In the housing frame 20 shown in FIG. 7, a metal plate having electrical insulation processing performed on the surface thereof is used, and both edges of this metal plate have a bent structure. The surface to which symbol 20A is given functions as the support surface of the driving circuit substrate 18 (shown by a broken line).

In the cover 21, a metal plate having electrical insulation processing performed on the surface thereof is used, and the upper edge of this metal plate has a bent structure. When the cover 21 is installed on the housing frame 20, a structure which is constituted by the housing frame 20 and the cover 21 is configured such that only a lower surface (surface on the ink jet head 14 side) is released.

The housing frame 20 and the cover 21 prevent a mist (fine droplets) generated when the ink jet head is brought into operation from being attached to the driving circuit substrate 18, and secure electrical insulation between the driving circuit substrate 18 and other components.

In addition, air vents are formed in the housing frame 20 and the cover 21 for the purpose of securing ventilation to the driving circuit substrate 18. A fan motor is disposed on the upper surface of the housing frame 20 or the cover 21, and thus the driving circuit substrate 18 can also be cooled by the flow of air discharged from the fan motor.

[Description of Driving Circuit]

FIG. 8 is a block diagram illustrating an electrical configuration of the driving circuit substrate 18, the flexible flat substrate 16 (16A, 16B) and the head module 22.

The ink jet head driving system 10 shown in the present example is configured such that ejection data which is sent out from a higher-level device 100 is converted into a power driving signal and a data control signal for bringing the ink jet head (head module 22) into operation by a driving circuit 102 mounted on the driving circuit substrate 18.

The amount of displacement and the displacement direction of the piezoelectric element 50 are determined by the power control signal. In addition, the piezoelectric element 50 (nozzle for performing ejection) to be operated is selected by the data control signal, and the operation timing (ejection timing) of each piezoelectric element is determined by the signal.

A common power driving signal is supplied to the blocks 22A and 22B. In other words, the power driving signal includes signals for two blocks 22A and 22B constituting the same head module 22. In addition, a common data control signal is sent out to the blocks 22A and 22B. In other words, the data control signal includes signals for two blocks 22A and 22B constituting the same head module 22.

The driving circuit 102 which is mounted on the driving circuit substrate 18 is configured to include a CPU (Central Processing Unit) 112 that controls signal processing of the ejection data which is transmitted from the higher-level device 100 as a whole, a logic array 114 in which signal processing is executed, a D/A converter 116 that converts a digital-format driving waveform data row into an analog format, an AMP 118 that amplifies the driving waveform data row converted into the analog format, and a level conversion unit 120 that performs a level conversion process on the data control signal, generated in the logic array 114, which passes through a buffer 119.

In addition, the CPU 112, the logic array 114, the D/A converter 116, and the AMP 118 constitutes a power driving signal generation unit 122 (driving signal generation unit), and the CPU 112, the logic array 114, the buffer 119, and the level conversion unit 120 constitutes a data control signal generation unit 123.

An output of the power driving signal generation unit 122 (AMP 118) is configured such that one (one-system) wiring is branched into two-system wirings, and that the respective wirings are electrically connected to the terminals of the connectors 26A and 26B.

In addition, similarly, an output of the data control signal generation unit 123 (level conversion unit 120) is also configured such that one (one-system) wiring is branched into two-system wirings, and that the respective wirings are electrically connected to the terminals of the connectors 26A and 26B.

That is, a power driving signal wiring (driving signal wiring) for transmitting the power driving signal and a data control signal wiring (driving signal wiring) for transmitting the data control signal are branched from one system to two systems within the driving circuit substrate 18. One system is connected to the connector 26A, the other system is connected to the connector 26B, and the same current (high-frequency current) supplied from the same supply source flows to one system and the other system.

The same wiring structure can be applied to the flexible flat substrates 16A and 16B. That is, the allocations of the power driving signal and the data control signal to the terminals of the connectors 26A and 26B which are mounted on the driving circuit substrate 18 are made to be equivalent to each other, and thus the electrical wiring structures of the flexible flat substrates 16A and 16B are commonalized.

The head module 22 is configured such that a wiring of the power driving signal and a wiring of the data control signal are independent of each other for each of the blocks 22A and 22B. In addition, each head module 22 is provided with logic arrays 130 and 140 that develop two blocks' 22A and 22B worth of data control signals for each block, and switch ICs 134 and 144 including a plurality of analog switches 132 and 142 within one module.

The plurality of analog switches 132 and 142 are connected to a plurality of piezoelectric elements 50 on a one-to-one correspondence basis. When an analog switch is turned on by the data control signal which is a selection signal of the analog switch, the power driving signal is applied to a piezoelectric element 50 which is connected to the analog switch.

A reference potential of the power driving signal which is applied to the piezoelectric element 50 is formed in a driving waveform. That is, the low voltage side of a positive voltage is changed with reference to the high voltage side of a positive voltage (or, the high voltage side of a negative voltage is changed with reference to the low voltage side of a negative voltage).

As shown in FIG. 8, the reference potential of the driving circuit 102 and the reference potential of the head module 22 are insulated from each other.

Summarizing the above, the ink jet head driving system 10 is configured such that the head module 22 constituting the ink jet head 14 is symmetrically divided into two parts with respect to the movement direction of the recording medium 12.

The blocks 22A and 22B constituting the head module 22 have electrical circuits independent of each other formed therein. The power driving signal for fluctuating a reference potential so as to correspond to the driving waveform is applied to each of the blocks 22A and 22B with reference to the maximum voltage of the power driving signal.

The reference potentials of the head module 22 and the driving circuit 102 (driving circuit substrate 18) are insulated from each other.

The blocks 22A and 22B constituting one head module 22 are connected to the same driving circuit 102 through the flexible flat substrates 16A and 16B, respectively, and the power source, the power driving signal, and the data control signal are transmitted through the wiring patterns (driving signal patterns) of the flexible flat substrates 16A and 16B.

The driving circuit substrate 18 is erected above the ink jet head 14, and is configured such that the solder surface 18B side is supported by the housing frame 20. The component surface 18A side is covered with the cover 21, and the structure of the housing frame 20 and the cover 21 is configured such that the bottom (lower surface) of the ink jet head 14 side is released (see FIGS. 1 and 7).

The flexible flat substrates 16A and 16B electrically connect the driving circuit substrate 18 and the head module 22 through this released surface (see FIGS. 1 and 7).

In the present example, a driving type is illustrated in which the common power driving signal is applied to the plurality of piezoelectric elements 50 for each head module 22, and the application and non-application of the power driving signal to each piezoelectric element 50 are selectively switched by the data control signal, but it is also possible to apply a driving type in which an individual power driving signal (driving signal) is applied for each piezoelectric element.

Next, a technical problem solved by the ink jet head driving system 10 having the above-mentioned configuration and a configuration for solving the technical problem will be described in detail.

[Description of First Problem of the Present Invention]

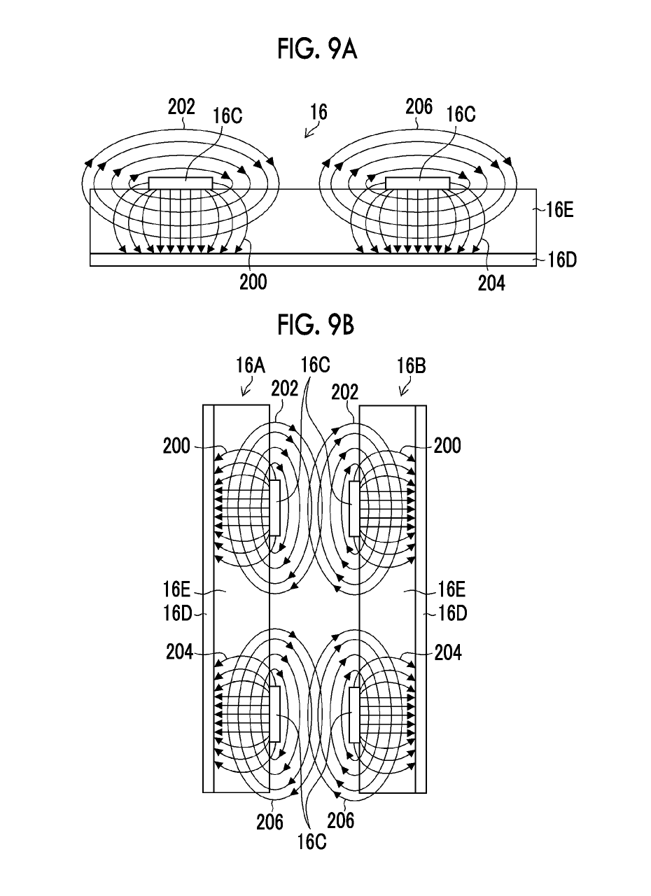

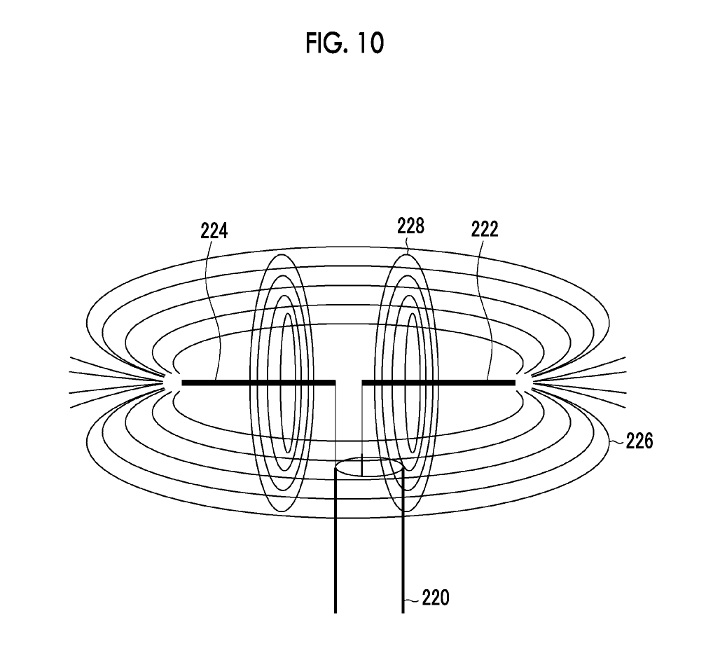

First, a first problem solved by the present invention will be described with reference to FIGS. 9A, 9B and 10. FIG. 9A is a diagram illustrating a magnetic field distribution which is generated in the flexible flat substrate 16, and FIG. 9B is a diagram illustrating a magnetic field distribution when the flexible flat substrates 16A and 16B forming a pair are caused to face each other and are disposed in parallel close to each other. In addition, FIG. 10 is a diagram illustrating a dipole (T-type) antenna.

As shown in FIG. 9A, the flexible flat substrate 16 includes at least two wiring layers. A signal line (driving signal pattern) and a power source line are formed on first layers 16C (first surfaces), and a reference potential line (reference potential pattern) caused by a return path of the signal line and a return path of the power source line is formed on a second layer 16D (second surface).

The first layers 16C and the second layer 16D have a layout serving as layers facing each other with an insulating layer (resin layer) 16E interposed therebetween.

Lines shown by symbol 200 in FIG. 9A schematically illustrate an electric field in a direction toward the return path from the signal line, and this electric field 200 is generated by a current flowing to the signal line. When the electric field 200 is generated, a magnetic field 202 is generated around the electric field 200.

In addition, lines shown by symbol 204 schematically illustrate an electric field in a direction toward the return path from the power source line, and this electric field 204 is generated by a current flowing to the power source line. When the electric field 204 is generated, a magnetic field 206 is generated around the electric field 204.

As shown in FIG. 9B, in the ink jet head driving system 10 shown in the present example, two flexible flat substrates 16A and 16B are configured such that first layers 16C are caused to face each other and are disposed in parallel close to each other. The signal line and the power source line (together with the first layers 16C) which are formed in each of the flexible flat substrates 16 and 16B are configured such that one system is branched into two systems in the driving circuit substrate 18, and the return lines (second layer) of the signal line and the power source line are also configured such that one system is branched into two systems in the driving circuit substrate 18 (see FIG. 8).

In the signal line of each of the flexible flat substrates 16A and 16B branched into two systems, data and a control signal of the block 22A, and a control signal and data including both data and a control signal of the block 22B are transmitted.

That is, a signal current and a power source current flow to two flexible flat substrates 16A and 16B forming a pair from the same driving circuit 102, and a current returns to the reference potential of the same driving circuit 102.

In this manner, since the wirings formed in the flexible flat substrates 16A and 16B have a microstrip structure, the electric fields 200 and 204 are generated between the signal line, the power source line (first layers 16C) and the reference potential line (second layer 16D) immediately below the signal line and the power source line, due to a high-frequency current flowing to the signal line and the power source line (first layers 16C), and the magnetic fields 202 and 206 perpendicular to the electric fields 200 and 204 are generated.

Since the flexible flat substrates 16A and 16B are not in contact with the housing frame (see FIG. 7) and are electrically insulated from each other, high-frequency noise (noise current) is not able to be caused to flow from the flexible flat substrates 16A and 16B to the housing frame 20, and electromagnetic waves (electromagnetic noise) caused by the magnetic fields 202 and 206 are intensively radiated from the flexible flat substrates 16A and 16B to the outside.

In addition, when the flexible flat substrates 16A and 16B are formed with a dipole antenna structure (dipole (T-type) antenna structure in which two wirings 222 and 224 are branched from the same wiring 220 and a T-type structure is formed) shown in FIG. 10, an electric field 226 caused by a high-frequency current flowing to two wirings 222 and 224 is generated, a magnetic field 228 is generated around this electric field 226, and electromagnetic waves (electromagnetic noise) have a tendency to be radiated to the outside.

On the other hand, the lengths of wirings (the total length of a wiring pattern of the driving circuit 102 to the driving circuit substrate and a wiring pattern within the flexible flat substrates 16A and 16B and each block) for transmitting signals to each of two blocks 22A and 22B constituting the same head module 22 which are branched from the same driving circuit 102 are equal to each other, and a time delay between the signals transmitted to each of the blocks 22A and 22B or a deterioration in waveform quality (a fluctuation in waveform) is prevented.

The magnetic field 202 generated from the flexible flat substrate 16A and the magnetic field 206 generated from the flexible flat substrate 16B are opposite to each other in direction between the flexible flat substrates 16A and 16B, and have an offset relation.

On the other hand, as shown in FIG. 10, two equal length wirings branched from one output may form a dipole (T-type) antenna structure in which noise which is generated within the driving circuit 102 is efficiently converted into electromagnetic waves.

Particularly, in the full line-type ink jet head in which the plurality of head modules 22 shown in FIG. 1 are lined up, the driving circuit substrate 18 and the flexible flat substrates 16A and 16B are lined up corresponding to the arrangement of the head modules 22, and thus there may be a concern of the respective substrates constituting a dipole antenna.

A plurality of head modules 22 are driven at the same driving timing. Even when a strong housing shield is mounted, electromagnetic waves (electromagnetic noise) leak to the outside.

Further, in the aforementioned ink jet head driving system 10, a ground line of an electrical circuit of each head module 22 and a ground line of the driving circuit substrate 18 are electrically insulated from each other, and thus there are also restrictions in which a shield wire is not able to be used in the flexible flat substrates 16A and 16B.

Then, the flexible flat substrates 16A and 16B are prevented from functioning as a dipole antenna by performing countermeasures other than the shield wire, and the electromagnetic waves (electromagnetic noise) radiated from the flexible flat substrates 16A and 16B to the outside have to be suppressed.

Summarizing the above, the first problem that the present invention is to solve is to suppress the electromagnetic waves (electromagnetic noise) radiated from the flexible flat substrates 16A and 16B to the outside by the high-frequency current of the power driving signal and the high-frequency current of the data control signal which are transmitted from the driving circuit 102 to the head module 22.

[Description of Second Problem]

Next, returning to FIGS. 1 and 2, a second problem of the present invention will be described. As shown in FIGS. 1 and 2, the solder surface 18B of the driving circuit substrate 18 has the housing frame 20 disposed at a close position.

Then, when the connector 26 (26A, 26B) on the driving circuit substrate 18 side which is connected to the connector 24 (24A, 24B) of the flexible flat substrate 16 (16A, 16B) is mounted on the solder surface 18B of the driving circuit substrate 18, the insertion and extraction of the connector 24 may not be accurately performed during maintenance such as the exchange of the head module 22.

On the other hand, it may be difficult to array and mount the connectors 26 on the component surface 18A of the driving circuit substrate, due to restrictions on an arrangement space in the driving circuit substrate 18 and restrictions on routing of the wiring patterns.

Therefore, the second problem solved by the present invention is to allow the insertion and extraction of the connector on the flexible flat substrate 16 side to be performed easily in a state where the driving circuit substrate 18 is installed onto the housing frame 20 even when there are restrictions on a space in which the connector 26 in the driving circuit substrate 18 is mounted.

In the ink jet head driving system 10 shown in the present example, configurations for solving the first problem and the second problem described above are adopted.

[Detailed Description of Flexible Flat Substrate]

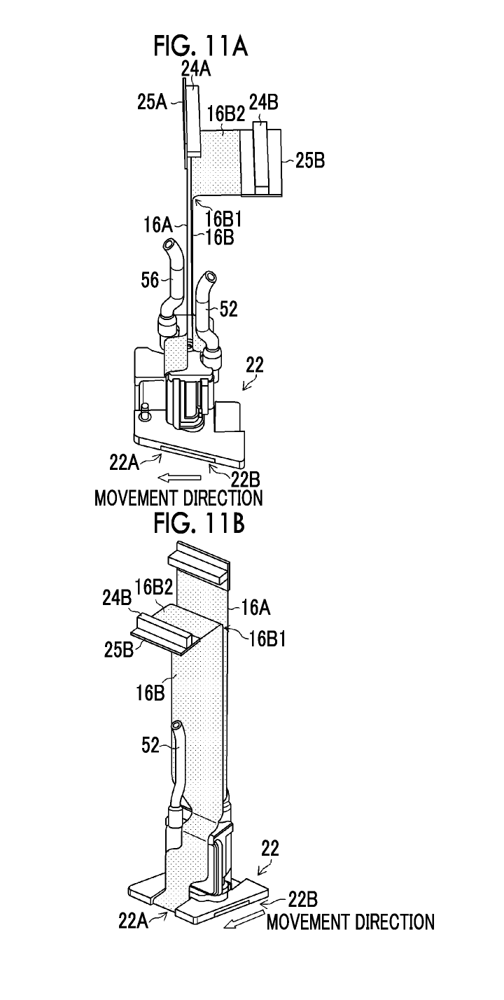

FIGS. 11A and 11B are perspective views illustrating an entire structure of the flexible flat substrates 16A and 16B adopted in the ink jet head driving system 10 shown in FIG. 1; FIG. 11A is a diagram when the flexible flat substrates 16A and 16B are seen from the lateral side, and FIG. 11B is a diagram when the flexible flat substrates 16A and 16B are seen from the upper side.

As previously described, the head module 22 is constituted by the blocks 22A and 22B which are divided electrically equally. The flexible flat substrates 16A and 16B are connected to each of the blocks 22A and 22B.

Two (a pair connected to the same head module 22) flexible flat substrates 16A and 16B are configured such that the first layers 16C face each other and are disposed in parallel close to each other (see FIG. 9B).

Meanwhile, although not shown in FIGS. 9A and 9B, the first layers 16C of the flexible flat substrates 16A and 16B are covered with an insulating layer (an insulating layer is included in the first layers and the second layer), and thus the flexible flat substrate 16A and the flexible flat substrate 16B may come into contact with each other.

Returning to FIGS. 11A and 11B, the flexible flat substrate 16A which is disposed on the downstream side in the movement direction (shown by an arrow line) of the recording medium 12 is linearly disposed toward the upper side. On the other hand, the flexible flat substrate 16B which is disposed on the upstream side in the same direction is linearly disposed to midway toward the upper side, and is bent toward the upstream side in the movement direction of the recording medium 12 in a direction intersecting the flexible flat substrate 16A from midway.

In FIGS. 11A and 11B, symbol 16B1 is given to a position at which the flexible flat substrate 16B is bent, and symbol 16B2 is given to a portion at which the flexible flat substrate 16B is bent.

The length from the position 16B1 at which the flexible flat substrate 16B is bent to the connector 24B is the same as the length from a position corresponding to the position 16B1 at which the flexible flat substrate 16A is bent to the connector 24A.

When the flexible flat substrate 16A is bent, the lengths of the bent portions are the same as each other in the flexible flat substrates 16A and 16B. Further, the flexible flat substrate 16A and the flexible flat substrate 16B have an equal length (the same total length).

The “equal length (the same total length)” as used herein may include a case where the total lengths of the flexible flat substrates 16A and 16B are different from each other in a range exhibiting the same operational effect. For example, this includes a case or the like where the total lengths of the flexible flat substrates 16A and 16B are different from each other in a range of a manufacturing error.

It is preferable that the position 16B1 at which the flexible flat substrate 16B is bent is located at a position at which the connectors 24A and 24B of the flexible flat substrates 16A and 16B can be attached to the connectors 26A and 26B of the driving circuit substrate 18, and that is located in the vicinity of a position at which the connectors 24A and 24B are installed insofar as possible.

In addition, the bending angle of the flexible flat substrate 16B (angle between the bent portions of the flexible flat substrate 16A and the flexible flat substrate 16B) may be an angle at which the flexible flat substrate 16A and the flexible flat substrate 16B do not constitute the dipole (T-type) antenna shown in FIG. 10 (or, electromagnetic waves to be radiated are set to be within an allowable range even when the dipole (T-type) antenna is constituted), in a range of exceeding 0° and being equal to or less than 90°. In addition, the non-parallel portions of the flexible flat substrates 16A and 16B are asymmetric with respect to each other (asymmetric with respect to the extended lines of the parallel portions of the flexible flat substrates 16A and 16B).

Naturally, it is preferable that the bending angle of the flexible flat substrate 16B with respect to the flexible flat substrate 16A is set to an angle close to 0°.

That is, two flexible flat substrates 16A and 16B forming a pair which are connected to each of the different blocks 22A and 22B of the same head module 22 have an arrangement structure in which one substrate is bent from midway with respect to the other substrate, and have a structure (shape) in which the bending angle of one substrate with respect to the other substrate exceeds 0° and is less than 90° and the two are non-linear and asymmetric from a position at which the other substrate is bent. Therefore, the two flexible flat substrates 16A and 16B forming a pair do not constitute a dipole antenna which is a structure in which two linear conducting wires are disposed at a feeding point in a bilateral symmetry manner (exclude a dipole antenna structure from the origin of an oscillation source of electromagnetic waves), and thus the radiation of electromagnetic waves (electromagnetic noise) from the flexible flat substrates 16A and 16B is suppressed.

Meanwhile, FIGS. 11A and 11B show an aspect in which substrates 25A and 25B are installed onto the tip portions of the flexible flat substrates 16A and 16B, respectively, and the flexible flat substrates 16A and 16B and the connectors 24A and 24B are connected to each other through the substrates 25A and 25B, but the connection configuration between the flexible flat substrates 16A and 16B and the connectors 24A and 24B is not limited to the shown example, and another connection configuration may be applied.

In addition, FIGS. 11A and 11B show a portion of the supply pipe line 52 and a portion of the circulation pipe line 56.

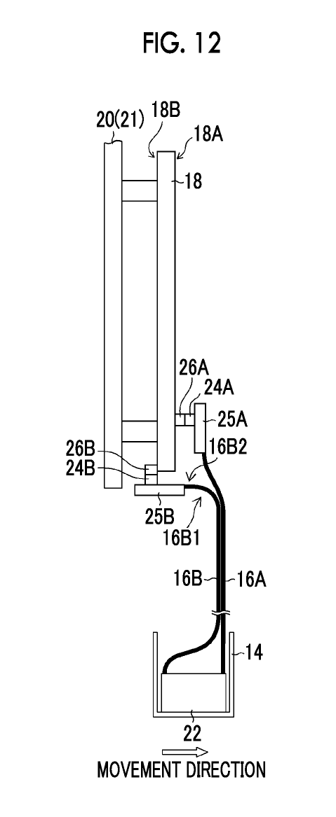

FIG. 12 is a side view schematically illustrating a connection configuration between the flexible flat substrates 16A and 16B and the driving circuit substrate 18.

As shown in the drawing, a straight type is applied to the connector 26A which is mounted onto the component surface 18A of the driving circuit substrate 18 (connected to the connector 24A of the flexible flat substrate 16A).

On the other hand, a right angle type is applied to the connector 26B which is mounted onto the solder surface 18B (connected to the connector 24B of the flexible flat substrate 16B).

The “straight-type” connector has a structure in which the tip of a pin extends vertically to the mounting surface, and the “right angle-type” connector has a structure in which the pin is bent at right angles to the mounting surface, and the tip of the pin extends parallel to the mounting surface.

That is, since the component surface 18A side (front surface side) is released, the connector 26A which is installed onto the component surface 18A does not interfere with the insertion and extraction of the connector 24A of the flexible flat substrate 16A, and the connector 24A can be disposed so as to be inserted and extracted in a direction perpendicular to the component surface 18A.

On the other hand, since the solder surface 18B has the housing frame 20 (cover 21) disposed at a close position, the insertion and extraction of the connector 24B of the flexible flat substrate 16B in a direction perpendicular to the solder surface 18B is interfered with by the housing frame 20 (cover 21).

Consequently, a direction in which the connector 24B of the connector 26B is inserted (extracted) is set to the downward direction (direction parallel to the solder surface 18B) of the driving circuit substrate 18, and thus the insertion and extraction of the connector 24B is not interfered with by the housing frame 20 (cover 21).

It is possible to mount the connector 26A to which the connector 24A of the flexible flat substrate 16A is connected and the connector 26B to which the connector 24B of the flexible flat substrate 16B connected, respectively, on the component surface 18A and the solder surface 18B, and to make the mounting spaces of the connectors 26A and 26B smaller, and the misconnection of the connectors 24A and 24B is prevented.

In the present example, two flexible flat substrates 16A and 16B have been illustrated, but the same is true of a case where three or more flexible flat substrates 16 are present. When three or more flexible flat substrates 16 are present, a substrate which is bent and a straight-shaped substrate which is not bent may be mixed, and all the flexible flat substrates 16 may be bent.

[Description of Another Aspect of Flexible Flat Substrate]

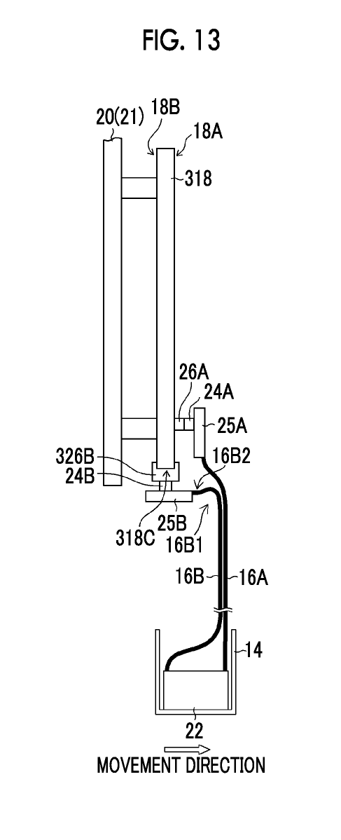

Next, another connection configuration between the flexible flat substrate and the driving circuit substrate will be described. FIG. 13 is a side view schematically illustrating another connection configuration between the flexible flat substrate and the driving circuit substrate.

Meanwhile, in the following description, components which are the same as or similar to the components described previously are denoted by the same reference numerals and signs, and thus the description thereof will not be given.

A driving circuit substrate 318 shown in the drawing is configured such that a straight-type connector 326B which is installed on a lower end surface 318C of the driving circuit substrate 318 is applied thereto, instead of the connector 26B which is mounted on the solder surface 18B of the driving circuit substrate 18 shown in FIG. 12.

That is, since the lower end surface 318C side of the driving circuit substrate 318 is released, the insertion and extraction of the connector 24B of the flexible flat substrate 16B are not interfered with by the housing frame 20 or the like, and thus it is possible to insert the connector 24B from the lower end surface 318C side of the driving circuit substrate 318, and to extract the connector 24B in the same direction.

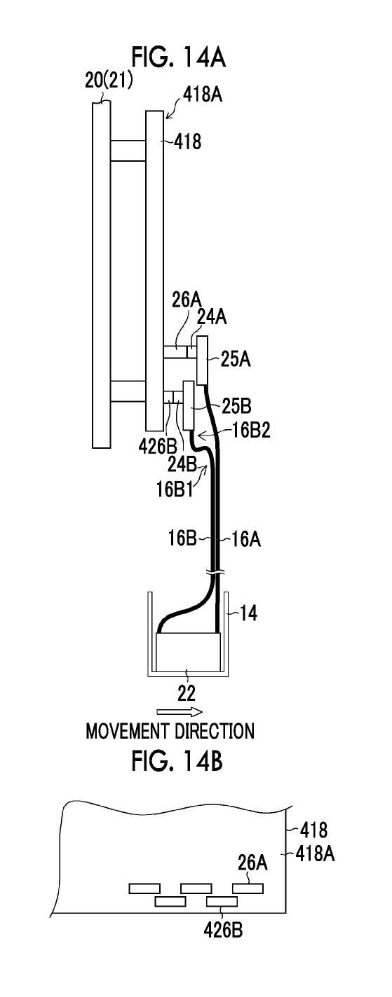

FIG. 14A is an entire side view schematically illustrating still another connection configuration between the flexible flat substrate and the driving circuit substrate, and FIG. 14B is a partial front view of the driving circuit substrate.

A driving circuit substrate 418 shown in FIGS. 14A and 14B is configured such that both the straight-type connector 26A which is connected to the connector 24A of the flexible flat substrate 16A and a straight-type connector 426B which is connected to the connector 24B of the flexible flat substrate 16B are mounted onto a component surface 418A.

As shown in FIG. 14B, a plurality of connectors 24A are disposed in a row in the longitudinal direction (horizontal direction in FIG. 14B) of the driving circuit substrate 418, and a plurality of connectors 426B are also disposed in a row in the longitudinal direction (horizontal direction in FIG. 14B) of the driving circuit substrate 418.

In addition, the connectors 26A are disposed close to each other to such an extent that another component (for example, connector 426B) is not mounted between the connectors 26A adjacent to each other, and the connectors 426B are disposed close to each other to such an extent that another component (for example, connector 26A) is not mounted between the connectors 426B.

That is, in the connection configuration shown in FIGS. 14A and 14B, the connector 26A that connects the connector 24A of the flexible flat substrate 16A and the connector 426B that connects the connector 24B of the flexible flat substrate 16B are mounted onto the component surface 418A, and thus the connector 24A of the flexible flat substrate 16A and the connector 24B of the flexible flat substrate 16B can be inserted and extracted from the component surface 418A side of the driving circuit substrate 418 which is released.

Meanwhile, the connector which is mounted onto the component surface 18A (418A) may have a right angle type applied thereto instead of a straight type.

[Application Example to Ink Jet Recording Apparatus]

Next, an application example with respect to the ink jet head driving system shown in the present example to an ink jet recording apparatus will be described.

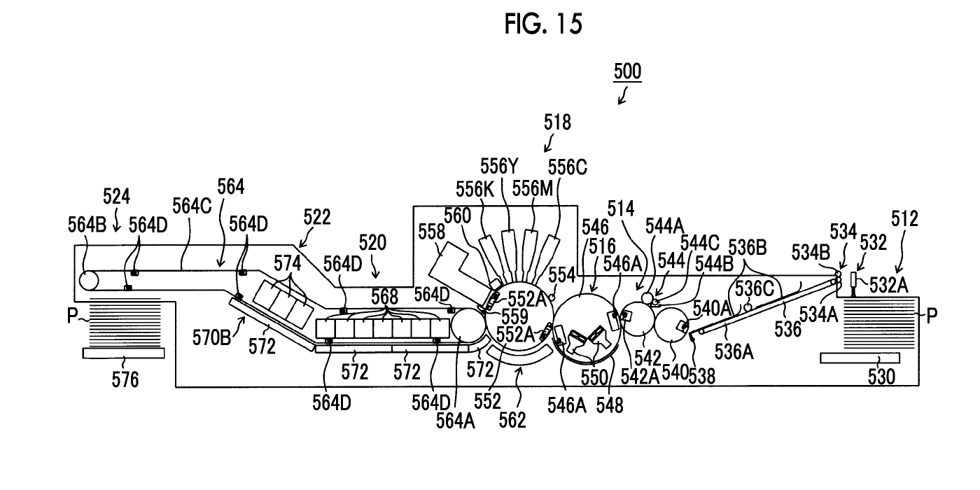

FIG. 15 is an entire configuration diagram of the ink jet recording apparatus to which the ink jet head driving system according to the embodiment of the present invention is applied.

An ink jet recording apparatus 500 shown in the drawing is an ink jet recording apparatus that records an image in an ink jet type on a paper sheet P using aqueous UV ink (UV (ultraviolet) curing-type ink using an aqueous medium).

The ink jet recording apparatus 500 is configured to mainly include a sheet feed unit 512 that feeds the sheet P, a process liquid providing unit 514 that provides a process liquid to the surface of the sheet P which is fed from the sheet feed unit 512, a process liquid drying processing unit 516 that performs a drying process on the sheet P to which the process liquid is provided by the process liquid providing unit 514, an image forming unit 518 that records an image in an ink jet type on the surface of the sheet P on which the drying process is performed by the process liquid drying processing unit 516, using aqueous UV ink, an ink drying processing portion 520 that performs the drying process on the sheet P on which the image is recorded by the image forming unit 518, a UV irradiation processing unit 522 that fixes an image by irradiating the sheet P on which the drying process is performed by the ink drying processing portion 520 with UV light (active ray), and a sheet discharge unit 524 that discharges the sheet P on which a UV irradiation process is performed by the UV irradiation processing unit 522.

The sheet P has a general-purpose printing sheet such as coated paper (such as art paper, coated paper, lightweight coated paper, and fine coated paper) applied thereto. Here, the “coated paper” is paper which is provided with a coat layer by applying a coating material to the surface of high-quality paper, neutralized paper or the like on which surface treatment is not performed.

<Sheet Feed Unit>

The sheet feed unit 512 is configured to mainly include a sheet feed stand 530, a suction device 532, a sheet feed roller pair 534, a feeder board 536, a front stop 538, and a sheet feed drum 540, and feeds the sheets P loaded into the sheet feed stand 530 one by one to the process liquid providing unit 514.

The sheets P loaded onto the sheet feed stand 530 are pulled up one by one in order from above by the suction device 532 (suction foot 532A), and are fed to the sheet feed roller pair 534 (between a pair of upper and lower rollers 534A and 534B).

The sheet P fed to the sheet feed roller pair 534 is sent out forward by the pair of upper and lower rollers 534A and 534B, and is placed on the feeder board 536. The sheet P placed on the feeder board 536 is transported by a tape feeder 536A which is provided on the transport surface of the feeder board 536.

In the transport process, while being pressed against the transport surface of the feeder board 536 by a retainer 536B and a roller 536C, irregularities are corrected. The sheet P transported by the feeder board 536 has the inclination thereof corrected by the tip being brought into contact with the front stop 538, and then is delivered to the sheet feed drum 540. The sheet is transported to the process liquid providing unit 514 by the sheet feed drum 540.

<Process Liquid Providing Unit>

The process liquid providing unit 514 is configured to mainly include a process liquid providing drum 542 that transports the sheet P and a process liquid providing unit 544 that provides a predetermined process liquid to the surface of the sheet P which is transported by the process liquid providing drum 542, and provides (applies) the process liquid to the surface of the sheet P.

As the process liquid which is applied to the surface of the sheet P, a process liquid is applied which has a function of agglutinating color materials in aqueous UV ink ejected onto the sheet P by the image forming unit 518 located at the subsequent stage. The aqueous UV ink is ejected by applying the process liquid to the surface of the sheet P, and thus high-quality printing can be performed without causing landing interference or the like even when a general-purpose printing sheet is used.

The sheet P delivered from the sheet feed drum 540 (gripper 540A) of the sheet feed unit 512 is delivered to the process liquid providing drum 542. The process liquid providing drum 542 winds the sheet P around its circumferential surface and transports the sheet by grasping and rotating the tip of the sheet P using a gripper 542A.

In this transport process, the process liquid is applied to the surface of the sheet P by pressing and contacting a coating roller 544A against the surface of the sheet P. Meanwhile, a configuration in which the process liquid is applied is not limited to an aspect in which the process liquid is supplied from a process liquid tray 544B to the coating roller 544A using an anilox roller 544C. In addition, an application configuration is also not limited to a roller application, and other configurations such as an ink jet type and an application using a blade can also be applied.

<Process Liquid Drying Processing Unit>

The process liquid drying processing unit 516 is configured to mainly include a process liquid drying processing drum 546 that transports the sheet P, a sheet transport guide 548 that supports (guides) the rear surface of the sheet P, and a process liquid drying processing unit 550 that dries the surface of the sheet P, transported by the process liquid drying processing drum 546, by blowing hot air onto the surface, and performs a drying process on the sheet P of which the surface is provided with the process liquid.

The tip of the sheet P delivered from the process liquid providing drum 542 of the process liquid providing unit 514 to the process liquid drying processing drum 546 is grasped by a gripper 546A provided in the process liquid drying processing drum 546.

In addition, the rear surface of the sheet P is supported by the sheet transport guide 548 in as state where the surface (surface to which a process liquid is applied) is directed to the inside. The sheet P is transported by rotating the process liquid drying processing drum 546 in this state.

In a process of being transported by the process liquid drying processing drum 546, hot air is blown onto the surface of the sheet P from the process liquid drying processing unit 550 which is installed inside the process liquid drying processing drum 546, the drying process is performed on the sheet P, a solvent component in the process liquid is removed, and an ink agglutination layer is formed on the surface of the sheet P.

<Image Forming Unit>

The image forming unit 518 is configured to mainly include an image forming drum 552 (an example of the relative movement device) that transports the sheet P, a sheet pressing roller 554 that presses the sheet P transported by the image forming drum 552 and tightly attaches the sheet P to the circumferential surface of the image forming drum 552, ink jet heads 556C, 556M, 556Y, and 556K that eject ink droplets of each color of C, M, Y, and K onto the sheet P, an inline sensor 558 that reads an image recorded on the sheet P, a mist filter 560 that traps ink mist, and a drum cooling unit 562, and plots a color image on the surface of the sheet P by ejecting droplets of ink (aqueous UV ink) of each color of C, M, Y, and K onto the surface of the sheet P having a process liquid layer formed thereon.

In addition, the ink jet head applied to the present example may have a full line-type ink jet head applied thereto in which nozzles are formed over a length corresponding to the total width of the sheet P (total length in a main scanning direction perpendicular to the transport direction of the sheet P), and may have a serial-type ink jet head shorter than the total width of the sheet P applied thereto.

The tip of the sheet P delivered from the process liquid drying processing drum 546 of the process liquid drying processing unit 516 to the image forming drum 552 is grasped by a gripper 552A provided in the image forming drum 552. Further, the sheet P is attached tightly to the circumferential surface of the image forming drum 552 by passing the sheet P through the lower portion of the sheet pressing roller 554.

The sheet P attached tightly to the circumferential surface of the image forming drum 552 is adsorbed by a negative pressure generated in absorption holes formed in the circumferential surface of the image forming drum 552, and is adsorptively held on the circumferential surface of the image forming drum 552.

When the sheet P which is transported in a state of being adsorptively held on the circumferential surface of the image forming drum 552 passes through an ink ejection region located immediately below each of the ink jet heads 556C, 556M, 556Y, and 556K, droplets of ink of each color of C, M, Y, and K are ejected onto the surface from each of the ink jet heads 556C, 556M, 556Y, and 556K, and a color image is plotted on the surface.

Ink ejected onto the surface of the sheet P is fixed the surface of the sheet P without causing feathering, breeding or the like by reaction with the ink agglutination layer formed on the surface of the sheet P, and a high-quality image is formed on the surface of the sheet P.

When the sheet P on which an image is formed by the ink jet heads 556C, 556M, 556Y, and 556K passes through a reading region of the inline sensor 558, the image formed on the surface is read.

The reading of an image by the inline sensor 558 is performed as necessary, and an image defect (image abnormality) such as defective ejection or concentration unevenness is inspected from read data of the image. The sheet P having passed through the reading region of the inline sensor 558 passes through the lower portion of a guide 559 after adsorption is released, and is delivered to the ink drying processing portion 520.

Meanwhile, the ink jet head 14 shown in FIG. 1 and the like is applied to the ink jet heads 556C, 556M, 556Y, and 556K shown in FIG. 15.

<Ink Drying Processing Portion>

The ink drying processing portion 520 is configured to include an ink drying processing units 568 that performs a drying process on the sheet P which is transported by a chain gripper 564, performs the drying process on the sheet P after image formation, and removes liquid components remaining on the surface of the sheet P.

A configuration example of the ink drying processing unit 568 includes a heat source such as a halogen heater or an infrared (IR) heater, and a fan that blows air (gas, fluid) heated by the heat source onto the sheet P.

The tip of the sheet P delivered from the image forming drum 552 of the image forming unit 518 to the chain gripper 564 (component of the recording medium transport device described later in detail) is grasped by a gripper 564D provided in the chain gripper 564.

The chain gripper 564 has a structure in which a pair of endless chains 564C are wound around a first sprocket 564A and a second sprocket 564B.

In addition, the rear surface of the rear end of the sheet P is adsorptively held on the sheet holding surface of a guide plate 572 disposed at a constant distance between the chain gripper 564 and the surface.

<UV Irradiation Processing Unit>

The UV irradiation processing unit 522 (an active ray irradiation device) is configured to include a UV irradiation unit 574, and irradiates the recorded image with ultraviolet rays using aqueous UV ink, to fix the image onto the surface of the sheet P.

A configuration example of the UV irradiation unit includes an ultraviolet light source that generates UV light and an optical system functioning as a device to condense UV light, a device to deflect UV light, or the like.

When the sheet P which is transported by the chain gripper 564 reaches the UV light irradiation region of the UV irradiation unit 574, a UV irradiation process is performed by the UV irradiation unit 574 installed inside the chain gripper 564.

An image (ink) which is irradiated with UV light expresses curing reaction and is fixed to the surface of the sheet P.

The sheet P on which the UV irradiation process is performed is sent to the sheet discharge unit 524 via an inclined transport path 570B. A cooling processing unit that performs a cooling process on the sheet P passing through the inclined transport path 570B may be included.

<Sheet Discharge Unit>

The sheet discharge unit 524 that recovers the sheet P on which a series of image forming processes are performed is configured to include a sheet discharge stand 576 that stacks and recovers the sheet P.

The chain gripper 564 (gripper 564D) opens the sheet P on the sheet discharge stand 576, and stacks the sheet P on the sheet discharge stand 576. The sheet discharge stand 576 stacks and recovers the sheet P opened from the chain gripper 564. The sheet discharge stand 576 is provided with sheet stops (such as a front sheet stop, a rear sheet stop, and a lateral sheet stop), not shown, so that the sheet P is stacked in an orderly manner.

In addition, the sheet discharge stand 576 is provided so as to be capable of being elevated by a sheet discharge stand ascending and descending device which is not shown. The sheet discharge stand ascending and descending device controls driving in conjunction with an increase or decrease in the sheets P stacked on the sheet discharge stand 576, and elevates the sheet discharge stand 576 so that the sheet P located at a highest position is located at a constant height at all times.

Meanwhile, although not shown in the drawing, the ink jet recording apparatus 500 shown in FIG. 15 is configured to include a system control unit that integrally controls the entire device, a driving signal generation unit that generates a driving signals (power driving signal and data control signal) by performing image processing on image data, and a control unit that performs control of each unit of the device on the basis of a command signal which is sent out from the system control unit.

In the ink jet head driving system described above, changes, additions, and deletions of components can be made appropriately without departing from the spirit or scope of the present invention. In addition, the aforementioned configuration examples can also be appropriately combined.

In the present specification, the ink jet recording apparatus has been illustrated as an apparatus configuration example to which the ink jet head driving system is applied, but the present invention can also be widely applied to liquid ejection apparatuses other than the ink jet recording apparatus.

[Invention Disclosed in the Present Specification]

As can be understood from the description of the aforementioned embodiment of the present invention, the present specification includes discloses of various technical ideas including at least the inventions described below.

(First Aspect) There is provided a liquid ejection head driving system including: a liquid ejection head including a plurality of nozzles that eject a liquid and a plurality of pressurizing elements that pressurize the liquid ejected from the nozzles; a driving circuit substrate including a driving signal generation unit in which a driving signal supplied to the plurality of pressurizing elements is generated, a driving signal wiring that branches an output of the driving signal generation unit into two or more systems, and a plurality of circuit-side connectors that extract the driving signal wiring for each of the systems; a support member that supports the driving circuit substrate; and the same number of wiring substrates as that of the system in which a wiring-side connector connected to the circuit-side connector is installed, a driving signal pattern for transmitting the driving signal for each of the systems is formed on a first surface, and a reference potential pattern of the driving signal is formed on a second surface on an opposite side to the first surface, wherein the plurality of wiring substrates are disposed in parallel so as to be brought close to each other by causing the first surfaces to face each other, and the driving circuit substrate is configured such that the same number of circuit-side connectors as the number of wiring substrates are mounted at a position where a direction of insertion and extraction of the wiring-side connector of the wiring substrate is released.

According to the first aspect, since a plurality of wiring substrates to which the driving signal branched into a plurality of systems is transmitted are disposed in parallel so s to be brought close to each other by causing the first surfaces to face each other, magnetic fields caused by currents of the driving signals generated in the respective wiring substrates cancel each other out, and the radiation of electromagnetic waves (electromagnetic noise) from the respective wiring substrates is suppressed.

In addition, since the driving circuit substrate has the circuit-side connector mounted at a position where the direction of insertion and extraction of the wiring-side connector provided in the wiring substrate is released, it is possible to easily perform the attachment and detachment of the wiring substrate to and from the driving circuit substrate during maintenance, without any interference when the wiring-side connector is inserted and extracted.

(Second Aspect) In the liquid ejection head driving system according to the first aspect, the driving circuit substrate is supported by the support member from a support surface side on a rear side of a release surface, and the plurality of circuit-side connectors include a straight angle-type connector or a right angle-type connector which is mounted on the release surface, and a right angle-type connector which is mounted on the support surface.

According to the second aspect, the right angle-type circuit-side connector is mounted on the support surface of the driving circuit substrate on which the support member is disposed. Therefore, even when a gap between the driving circuit substrate and the support member is small, it is possible to perform the insertion and extraction of the wiring-side connector (wiring substrate) into and from the circuit-side connector which is mounted on the support surface of the driving circuit substrate.

It is preferable that the circuit-side connector which is mounted on the support surface of the driving circuit substrate is mounted in the vicinity of the end surface of the support surface.

(Third Aspect) In the liquid ejection head driving system according to the first aspect, the driving circuit substrate is supported by the support member from a support surface side on a rear side of a release surface, and the plurality of circuit-side connectors include a straight angle-type connector or a right angle-type connector which is mounted on the release surface, and a straight angle-type connector which is mounted on an end surface.

According to the third aspect, a portion of the straight-type circuit-side connector is mounted on the end surface of the driving circuit substrate. Therefore, even when a gap between the driving circuit substrate and the support member is small, it is possible to perform the insertion and extraction of the wiring-side connector (wiring substrate) into and from the circuit-side connector which is mounted on the end surface of the driving circuit substrate.

(Fourth Aspect) In the liquid ejection head driving system according to the first aspect, the driving circuit substrate is supported by the support member from a support surface side on a rear side of a release surface, and the plurality of circuit-side connectors are a straight angle-type connector or a right angle-type connector which is mounted on the release surface.

According to the fourth aspect, the circuit-side connector is disposed on the release surface opposite to the side on which the support member is disposed. Therefore, even when a gap between the driving circuit substrate and the support member is small, it is possible to perform the insertion and extraction of the wiring-side connector (wiring substrate) into and from the circuit-side connector which is mounted on the release surface of the driving circuit substrate.

(Fifth Aspect) In the liquid ejection head driving system according to any one of the first aspect to the fourth aspect, some or all of the plurality of wiring substrates have an asymmetrically bent structure in which an angle exceeding 0° and equal to or less than 90° with respect to another wiring substrate is formed in a the vicinity of the position at which the wiring-side connector is installed.

According to the fifth aspect, the formation of a dipole antenna by a plurality of wiring substrates is suppressed, and the radiation of electromagnetic waves (electromagnetic noise) from the wiring substrates is suppressed.

A position at which the wiring substrate is bent (vicinity of a position at which the wiring-side connector is installed) is determined depending on a condition in which the wiring-side connector can be reliably inserted into the circuit-side connector. In addition, it is preferable that the position at which the wiring substrate is bent is as close to the wiring-side connector as possible.

(Sixth Aspect) In the liquid ejection head driving system according to fifth aspect, the plurality of wiring substrates include a plurality of the bent wiring substrates, and lengths from bending positions of the bent wiring substrates to the wiring-side connector are equal to each other.

According to the sixth aspect, the lengths from the bending positions of the bent wiring substrates to the wiring-side connector are made to be equal to each other, and thus it is possible to form each wiring substrate as an equal length wiring, and to offset a magnetic field generated in each wiring substrate by a magnetic field generated in another wiring substrate.

(Seventh Aspect) In the liquid ejection head driving system according to the fifth aspect, the plurality of wiring substrates include the bent wiring substrate and a wiring substrate which is not bent, and a length from a bending position of the bent wiring substrate to the wiring-side connector is equal to a length from a position corresponding to the bending position of the wiring substrate which is not bent to the wiring-side connector.

According to the seventh aspect, it is possible to make a wiring of a bent wiring substrate and a wiring of a wiring substrate which is not bent equal to each other in length, and to offset a magnetic field generated in each wiring substrate by a magnetic field generated in another wiring substrate.

(Eighth Aspect) In the liquid ejection head driving system according to any one of the first aspect to the seventh aspect, the system further includes a relative movement device configured to relatively move the liquid ejection head and a medium for attaching the liquid ejected from the liquid ejection head with respect to each other, wherein the liquid ejection head is divided into a plurality of blocks in a movement direction of the relative movement device, the driving circuit substrate is configured such that a driving signal wiring that branches the output of the driving signal generation unit into a system for each of the blocks is formed thereon, and each of the wiring substrates different from each other is connected to each block.

According to the eighth aspect, it is possible to suppress the radiation of electromagnetic waves (electromagnetic noise) from the wiring substrate for transmitting the driving signal to a plurality of blocks.

(Ninth Aspect) In the liquid ejection head driving system according to any one of the first aspect to the seventh aspect, the system further includes a relative movement device configured to relatively move the liquid ejection head and a medium for attaching the liquid ejected from the liquid ejection head with respect to each other, wherein the liquid ejection head has a structure in which a plurality of head modules are linked together in a direction perpendicular to a movement direction of the relative movement device, the head module includes two blocks divided in the movement direction, the driving circuit substrate includes a plurality of the driving signal generation units for each head module, and is configured such that a driving signal wiring that branches the output of the driving signal generation unit for each head module into a system for each of the blocks is formed for each head module, the wiring substrate is provided for each of the head modules, and each of the wiring substrates different from each other is connected to each of the head modules.

According to the ninth aspect, a plurality of head modules are linked together along a direction perpendicular to the relative movement direction of the relative movement device, and thus a full line-type liquid ejection head may be formed.

(Tenth Aspect) In the liquid ejection head driving system according to any one of the first aspect to the ninth aspect, the liquid ejection head has a driving signal transmission wiring for transmitting a driving signal to the pressurizing element formed therein, and the driving signal transmission wiring is bonded directly to a wiring pattern of the wiring substrate.

According to the tenth aspect, in an aspect where the wiring substrate and the head module are formed integrally with each other, the generation of electromagnetic waves (electromagnetic noise) from the wiring substrate is also suppressed.

(Eleventh Aspect) In the liquid ejection head driving system according to any one of the first aspect to the tenth aspect, the driving signal generation unit includes a power driving signal generation unit that generates a power driving signal having a waveform corresponding to a driving waveform common to the plurality of pressurizing elements, and a data control signal generation unit that generates a data control signal for selectively switching between application and non-application of the power driving signal for each of the pressurizing elements.

In the eleventh aspect, it is preferable that a driving signal pattern in which the power driving signal and the data control signal are transmitted is formed on the first surface of the wiring substrate, a reference potential pattern of the power driving signal and the data control signal is formed on the second surface on the rear side of the first surface, and the first surfaces of a plurality of wiring substrates ae caused to face each other and are disposed in parallel close to each other.

(Twelfth Aspect) In the liquid ejection head driving system according to any one of the first aspect to the eleventh aspect, the support member is disposed above the liquid ejection head, and the driving circuit substrate is erected above the liquid ejection head, or is disposed so as to be laid down.

In the twelfth aspect, the driving circuit substrate may be erected at right angles to the liquid ejection head, and may be erected obliquely thereto.

(Thirteenth Aspect) In the liquid ejection head driving system according to any one of the first aspect to the twelfth aspect, the plurality of wiring substrates are configured such that the driving signal patterns thereof are equal to each other, and that lengths of the reference potential patterns thereof are equal to each other.

According to the thirteenth aspect, a wiring length for each system within the driving circuit substrate, a wiring length for each system in the wiring substrate, and a wiring length for each system within the liquid ejection head are made to be equal to each other, and thus the generation of electromagnetic waves (electromagnetic noise) generated in each unit is suppressed.

### EXPLANATION OF REFERENCES

10: ink jet head driving system
12: recording medium
14, 556C, 556M, 556Y, 556K: ink jet head
16, 16A, 16B: flexible flat substrate
18, 318, 418: driving circuit substrate
20: housing frame
21: cover
22: head module
22A, 22B: block
24, 24A, 24B, 26, 26A, 26B, 366B, 426B: connector
50: piezoelectric element
81: nozzle portion

What is claimed is:

1. A liquid ejection head driving system comprising:
a liquid ejection head including a plurality of nozzles that eject a liquid and a plurality of pressurizing elements that pressurize the liquid ejected from the nozzles;
a driving circuit substrate including a driving signal generation unit in which a driving signal supplied to the plurality of pressurizing elements is generated, a driving signal wiring that branches an output of the driving signal generation unit into two or more systems, and a plurality of circuit-side connectors that extract the driving signal wiring for each of the systems;
a support member that supports the driving circuit substrate; and
the same number of wiring substrates as that of the system in which a wiring-side connector connected to the circuit-side connector is installed, a driving signal pattern for transmitting the driving signal for each of the systems is formed on a first surface, and a reference potential pattern of the driving signal is formed on a second surface on an opposite side to the first surface, wherein:
the plurality of wiring substrates are disposed in parallel so as to be brought close to each other by causing the first surfaces to face each other, and
the driving circuit substrate is configured such that the same number of circuit-side connectors as the number of wiring substrates are mounted at a position where a direction of insertion and extraction of the wiring-side connector of the wiring substrate is released.

2. The liquid ejection head driving system as defined in claim 1, wherein the driving circuit substrate is supported by the support member from a support surface side on a rear side of a release surface, and the plurality of circuit-side connectors include a straight angle-type connector or a right angle-type connector which is mounted on the release surface, and a right angle-type connector which is mounted on the support surface.

3. The liquid ejection head driving system as defined in claim 1, wherein the driving circuit substrate is supported by the support member from a support surface side on a rear side of a release surface, and the plurality of circuit-side connectors include a straight angle-type connector or a right angle-type connector which is mounted on the release surface, and a straight angle-type connector which is mounted on an end surface.

4. The liquid ejection head driving system as defined in claim 1, wherein the driving circuit substrate is supported by the support member from a support surface side on a rear side of a release surface, and the plurality of circuit-side connectors are a straight angle-type connector or a right angle-type connector which is mounted on the release surface.

5. The liquid ejection head driving system as defined in claim 1, wherein some or all of the plurality of wiring substrates have an asymmetrically bent structure in which an angle exceeding 0° and equal to or less than 90° with respect to another wiring substrate is formed in a the vicinity of the position at which the wiring-side connector is installed.

6. The liquid ejection head driving system as defined in claim 5, wherein the plurality of wiring substrates include a plurality of the bent wiring substrates, and lengths from bending positions of the bent wiring substrates to the wiring-side connector are equal to each other.

7. The liquid ejection head driving system as defined in claim 5, wherein the plurality of wiring substrates include the bent wiring substrate and a wiring substrate which is not bent, and a length from a bending position of the bent wiring substrate to the wiring-side connector is equal to a length from a position corresponding to the bending position of the wiring substrate which is not bent to the wiring-side connector.

8. The liquid ejection head driving system as defined in claim 1, further comprising a relative movement device configured to relatively move the liquid ejection head and a medium for attaching the liquid ejected from the liquid ejection head with respect to each other, wherein:
the liquid ejection head is divided into a plurality of blocks in a movement direction of the relative movement device,
the driving circuit substrate is configured such that a driving signal wiring that branches the output of the driving signal generation unit into a system for each of the blocks is formed thereon, and
each of the wiring substrates different from each other is connected to each block.

9. The liquid ejection head driving system as defined in claim 1, further comprising a relative movement device configured to relatively move the liquid ejection head and a medium for attaching the liquid ejected from the liquid ejection head with respect to each other, wherein:
the liquid ejection head has a structure in which a plurality of head modules are linked together in a direction perpendicular to a movement direction of the relative movement device,
the head module includes two blocks divided in the movement direction,
the driving circuit substrate includes a plurality of the driving signal generation units for each head module, and is configured such that a driving signal wiring that branches the output of the driving signal generation unit for each head module into a system for each of the blocks is formed for each head module,
the wiring substrate is provided for each of the head modules, and
each of the wiring substrates different from each other is connected to each of the head modules.

10. The liquid ejection head driving system as defined in claim 1, wherein the liquid ejection head has a driving signal transmission wiring for transmitting a driving signal to the pressurizing element formed therein, and the driving signal transmission wiring is bonded directly to a wiring pattern of the wiring substrate.

11. The liquid ejection head driving system as defined in claim 1, wherein the driving signal generation unit includes a power driving signal generation unit that generates a power driving signal having a waveform corresponding to a driving waveform common to the plurality of pressurizing elements, and a data control signal generation unit that generates a data control signal for selectively switching between application and non-application of the power driving signal for each of the pressurizing elements.

12. The liquid ejection head driving system as defined in claim 1, wherein:
the support member is disposed above the liquid ejection head, and
the driving circuit substrate is erected above the liquid ejection head, or is disposed so as to be laid down.

13. The liquid ejection head driving system as defined in claim 1, wherein the plurality of wiring substrates are configured such that the driving signal patterns thereof are equal to each other, and that lengths of the reference potential patterns thereof are equal to each other.
